(19) United States
(12) Patent Application Publication
(10) Pub. No.: US 2025/0382755 A1
(43) Pub. Date: Dec. 18, 2025

(54) METHOD AND APPARATUS FOR LEVELING

(71) Applicant: MOBA Mobile Automation AG, Limburg (DE)

(72) Inventors: Alfons HORN, Limburg (DE); Martin ZARNIKO, Limburg (DE); Jürgen STILLER, Limburg (DE)

(21) Appl. No.: 19/240,140

(22) Filed: Jun. 17, 2025

(30) Foreign Application Priority Data
Jun. 17, 2024 (EP) 24182579.3

(51) Int. Cl. E01C 23/01; E01C 19/48

(52) U.S. Cl. CPC E01C 23/01; E01C 19/4873

(57) ABSTRACT

A leveling system for a road paver with a screed, having: a measuring system; and a controller; the measuring system having first and second sensors, the first sensor being arranged in front of the second sensor in the direction of travel and configured to measure a first distance from the first sensor to a further ground with an offset height level to obtain a first height value, and the second sensor being arranged in front of the screed and configured to measure a second distance from the second sensor to a ground or reference of the construction machine to obtain a second height value; the controller being configured to determine the offset based on the first and second height values by forming a difference, to determine a set value for an adjustment based on the offset, and to control the screed depending on the set value.

### CROSS-REFERENCE TO RELATED APPLICATION

This application claims priority from European Application No. 24182579.3, which was filed on Jun. 17, 2024, and is incorporated herein by reference in its entirety.

### TECHNICAL FIELD

Embodiments of the present invention relate to a leveling system and a corresponding method. Preferred embodiments relate to a method and an apparatus for layer thickness adjustment, in particular autonomous layer thickness adjustment, e.g. in the case of bridge structures or in the case of repair.

### BACKGROUND OF THE INVENTION

In the case of bridge constructions, the problem frequently arises that, owing to the changing ground, there is a ground offset at the transition to the bridge. Thus, for example, the ground in front of the bridge can have a different height level when compared to the other ground of the bridge, e.g. offset by a corresponding offset. The other ground can be, for example, the ground of the bridge plate or else the ground of a corresponding support of the bridge.

At the bridge transition or generally at the transition or change of the ground, there is a different height level, which gives rise to the above-mentioned offset. Adjusting the necks is currently largely achieved manually, to be precise in practice using manual switching to different individual sensors of the measuring system, such as, for example, the Big Sonic-Ski system or the Super-Ski system. In this case, the leveling is adapted manually in such a way that there is no step with a neck. Alternatively or additionally, a cable is used as a reference, which is tensioned approximately 40 to 50 m in front of the neck and is scanned by the measuring system in order to obtain a “clean” neck. Manual adaptation processes are not reproducible, which can have effects on the quality, and increase the personnel requirement, which has effects on the personnel efficiency. Therefore, there is need for an improved approach.

The object underlying the present invention is providing a concept for leveling which is improved with regard to efficiency and quality.

### SUMMARY

According to an embodiment, a leveling system for a road paver with a screed may have: a measuring system; and a controller; wherein the measuring system has a first and a second sensor, wherein the first sensor is arranged in front of the second sensor in the direction of travel and is configured to measure a first distance from the first sensor to a further ground or surface with a height level offset by an offset in order to obtain a first height value; and wherein the second sensor is arranged in front of the screed of the road paver in the direction of travel and is configured to measure a second distance from the second sensor to a ground of the construction machine or a reference of the construction machine in order to obtain a second height value; wherein the controller is configured to determine the offset on the basis of the first height value and the second height value by forming a difference, wherein the controller is also configured to determine a set value for adjustment on the basis of the offset; wherein the controller is configured to control the screed in dependence on the set value.

According to another embodiment, a method for operating a leveling system for a road paver with a screed may have the steps of: measuring a first distance from a first sensor to a further ground or surface with a height level offset by an offset, wherein the first sensor is arranged in front of the second sensor in the direction of travel in order to obtain a first height value; measuring a second distance from the second sensor to a ground of the construction machine or a reference of the construction machine in order to obtain a second height value; determining a set value for adjustment on the basis of the first height value and the second height value and determining a set value for adjustment on the basis of the offset; and controlling the screed in dependence on the set value.

Another embodiment may have a non-transitory digital storage medium having stored thereon a computer program having program code for performing a method for operating a leveling system for a road paver with a screed having the steps of: measuring a first distance from a first sensor to a further ground or surface with a height level offset by an offset, wherein the first sensor is arranged in front of the second sensor in the direction of travel in order to obtain a first height value; measuring a second distance from the second sensor to a ground of the construction machine or a reference of the construction machine in order to obtain a second height value; determining a set value for adjustment on the basis of the first height value and the second height value and determining a set value for adjustment on the basis of the offset; and controlling the screed in dependence on the set value, when the computer program is run by a computer.

Embodiments of the present invention provide a leveling system for a road paver (or road finisher) with a screed. The leveling system comprises a measuring system and a controller. The measuring system has at least two sensors, i.e. a first and a second sensor. The first sensor is arranged in front of the second sensor in the direction of travel and is configured to measure a first distance from the first sensor to another ground with a height level offset by an offset (when compared to ground) in order to obtain a first height value, wherein the second sensor is arranged in front of the screed of the road paver in the direction of travel and is configured to measure a second distance from the second sensor to a ground of the construction machine or a reference of the construction machine in order to obtain a second height value. The controller is configured to determine the offset by forming a difference based on the first height value and the second height value. Furthermore, the controller is configured to determine a set value for the adjustment on the basis of the offset and to control the screed in dependence on the set value.

According to embodiments, the set value (or also adjustment set value) can be determined taking into account a rolling measure. According to embodiments, the following calculation results from this:

set value for height control h_{Bset}=h_{F}+W, wherein h_{F} represents the measured offset and W the rolling measure.

Embodiments of the present invention are based on the finding that the ground in front of the road paver can be scanned by two “front” sensors such that an offset between the ground and further ground, which can be at a different height level, can be determined from this. Can be determined in this case means detecting the offset and also determining the offset. For example, two successive sensors determine their respective distance from the ground such that the offset can be determined by forming a difference between these two sensors. When knowing the offset, the screed (plank) can advantageously be controlled such that a transition to the changed height level is produced over an adjustment distance.

According to embodiments, a so-called adjustment (straight) line over the adjustment distance is used.

According to embodiments, the controller can be configured to control the screed in dependence on the adjustment line, which extends over an adjustment distance and/or a predefined adjustment distance. According to embodiments, the adjustment line is determined by a current layer thickness and/or by a height of the offset at the position and/or the set value. Thus, set values for the height control along the adjustment line can advantageously be determined via the adjustment line in order to control the screed on the basis of these set values. The layer thickness control can be configured to correct the offset via the adjustment distance. For this purpose, the layer thickness control compares e.g. the current (measured) layer thickness to the set thickness at the position of the offset. This process is automatable and therefore reproducible. This advantageously increases the quality of the transition. The transition can thus advantageously be optimized by the length of the adjustment distance.

According to embodiments, both determining the offset and detecting the offset, optionally using the adjustment distance and/or the adjustment line, are to be used in order to automate the levelling process also during the transition. This significantly increases the personnel efficiency since manual intervention is no longer necessary here.

According to embodiments, the controller can be configured to detect the offset in the ground; for example, the controller can be configured to detect the offset in the ground and to initiate the adjustment of the layer thickness.

At this point, it is to be noted that, according to embodiments, several sensors can be used instead of the first sensor and/or a plurality of sensors can be used instead of the second sensor. For example, the height values can be averaged over several sensors for a first height value or a first position. In analogy, it is also possible for several height values to be averaged over several sensors or positions for the second height value. Alternatively, it would also be conceivable for the height values, that is to say the first height value and the second height value, to be determined by using a so-called regression line. The regression line has the advantage that the offset can be reliably determined even if the measuring system is inclined.

According to embodiments, the controller has a flatness control loop; and/or is configured to perform the control of the screed using a prediction model and/or taking into account a behavior of the screed over time and/or the distance. The controller is configured to perform control on the basis of a difference or sum of a height reference and the set value or on the basis of a difference or sum of a height reference and the set value while considering a rolling measure.

According to embodiments, the controller is configured to correct the height values, determined by the one or more further sensors, starting from a position of the offset, e.g. in order to correct the offset. According to embodiments, a bar having several sensors is used as the measuring system. Front sensors or the foremost two sensors form the first and second sensor. The sensors located behind in the direction of travel also belong to the measuring system and are used, for example, for leveling or the flatness controller.

According to embodiments, the carrier can carry the first and second sensor. According to further embodiments, this carrier can also accommodate the further sensors, which are arranged further to the rear as seen in the direction of travel. According to further embodiments, the carrier can also extend beyond the screed behind the construction machine having further sensors or the measuring system can be continued by a further carrier behind the construction machine. This further carrier then accommodates, in analogy to the carrier extending behind the screed, one or more further sensors, which can be used for determining the layer thickness or also for leveling or the flatness controller. According to embodiments, the sensor value of the front sensors, such as, for example, the one or more further sensors, or the first and second sensors, can be corrected by the offset for the flatness controller or layer thickness determination or leveling. This advantageously makes it possible for the leveling/layer thickness determination/flatness control also to be continued beyond the position of the offset, that is to say, for example, beyond the bridge transition.

A further embodiment relates to a method for leveling. The method comprises the steps of:
measuring a first distance from a first sensor to a further ground or surface with a height level offset by an offset, wherein the first sensor is arranged in front of the second sensor in the direction of travel in order to obtain a first height value;
measuring a second distance from the second sensor to a ground of the construction machine or a reference of the construction machine in order to obtain a second height value;
determining a set value for an adjustment on the basis of the first height value and the second height value and determining a set value for an adjustment on the basis of the offset; and
controlling the screed in dependence on the set value.

According to embodiments, the method may of course also be computer-implemented. In this respect, a computer program or a data carrier comprising a computer program with a program code is provided, which executes or initiates the steps as have just been defined in the method.

### BRIEF DESCRIPTION OF THE DRAWINGS

Embodiments of the present invention will be explained below referring to the drawings, in which:

FIG. 1A shows a schematic representation of a construction machine, in particular a road paver, with a measuring system for leveling according to embodiments;

FIGS. 1B/1C show schematic enlarged representations of the measuring system from FIG. 1A;

FIG. 2 shows a schematic representation of the measuring system for use in layer thickness adjustment according to embodiments;

FIG. 3 shows a schematic representation of a construction machine having a measuring system for use according to embodiments;

FIG. 4 shows a schematic block diagram for explaining control loops in the layer thickness control according to embodiments; and

FIG. 5 shows a schematic representation for explaining the layer thickness control.

### DETAILED DESCRIPTION OF THE INVENTION

Before embodiments of the present invention will be explained below referring to the attached drawings, it is to be noted that elements and structures having the same effect are provided with the same reference numerals so that the description thereof is mutually applicable or interchangeable.

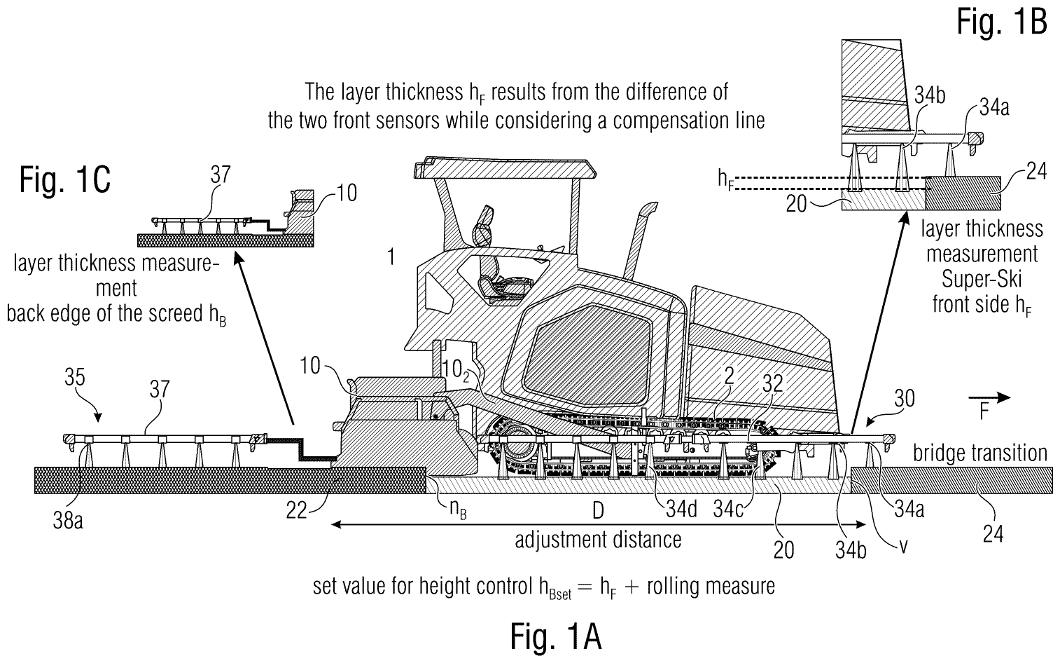

FIG. 1A shows a road paver 1 with a screed 10 which is pulled by the road paver 1 or a tractor via a pull arm 10z. The road paver 1 travels on a ground 20 in the direction of travel F by means of the chassis 2.

A first part 30 of the measuring system is arranged on the road paver 10, which exemplarily comprises a carrier 32 and at least two sensor heads 34a and 34b. Furthermore, one or more further sensors 34c, 34d, etc. of the same type may optionally be arranged on the carrier 32 of the sensor system part 30. These sensors 34a and 34b are shown to be enlarged in FIG. 1B. In this case, the sensor 34a is the foremost sensor or at least arranged in front of the sensor 34b. The sensor 34b is arranged between the screed 10 and the sensor 34a. Both are oriented from the carrier 32 onto the ground 20 or further ground 24.

Optionally, it is to be noted that the sensor system may also have a further part 35 with a further carrier 37 and further sensors 38a (cf. FIG. 1C). The further part 35 of the measuring system is arranged behind the road paver 1, whereas the first part 30 of the sensor system is arranged in front of or laterally at the level of the chassis 32. Preferably, the carrier 32 is configured such that the sensor 34a and/or also the sensor 34b are located in front of the road paver 1. For example, the carrier 32 may be arranged on the pull arm 10z.

After having explained the structure of the road paver 1, the mode of operation of the road paver 1 and that of the measuring system 30 will be discussed briefly below. The road paver 1 moves on the ground 20 in the direction of travel F and is configured to apply an asphalt layer 22 to the ground 20 by means of the screed 10. Owing to the layer thickness h_{B}, this asphalt layer 22 has a difference in height with respect to the ground 20. The ground 20 is typically as level as possible, unevenness being compensated for by a so-called leveling system of the road paver 1. The leveling system is based, for example, on the sensors of the sensor system part 30. In some conditions, for example in the case of bridge transitions, that is to say in the case of the transition from conventional road substructures 20 to bridge regions 24, there may be an offset V. This offset is characterized, for example, by the fact that the other ground 24 has a height level offset by the offset V when compared to the ground 20. This offset V can be determined by means of the two sensors 34a and 34b, wherein the sensor 34a is designated first sensor and the sensor 34b is designated second sensor. Both sensors 34a and 34b are configured to determine a distance, in particular a height from the sensor 34a or 34b, to the respective ground 20 and 24. As shown here, the first sensor 34a determines the distance from the other ground 24, while the second sensor 34b determines the distance from the ground 20. The offset V can be detected and also determined on the basis of a difference or on the basis of a difference in the resulting height values (first height value determined by the sensor 34a and second height value determined by the sensor 34b).

For this purpose, according to embodiments, the measuring system comprises a controller (not shown) which receives the first and second height values of the sensors 34a and 34b and determines the offset by forming a difference. The height of the offset is characterized by h_{F}. The height h_{F} of the offset V and thus the layer thickness to be targeted before the offset V results, for example, from the difference between the two front sensors 34a and 34b while considering an adjustment line.

According to embodiments, a set value h_{Bset} for the location of the offset can be determined on the basis of this offset, which indicates the layer thickness of the layer to be applied or shortly before the position of the offset V. According to embodiments, a rolling measure can also be taken into account, for example that the set value would have to be reduced. This results, for example, in the formula for the set value of the height control

$${h}_{Bset} = {h}_{F} + W ,$$

wherein W represents the rolling measure.

The controller is also configured to vary the layer thickness of h_{B} at the position of the screed via the adjustment distance D such that the set value h_{Bset} is reached at the position of the offset.

By means of the above-mentioned adjustment line, which in principle represents a compensation line, the height control is adjusted from the current position of the screed 10 to the position of the offset V. Consequently, this results in (adjustment) set values along the adjustment line. The adjustment line connects the current layer thickness h_{B} at the current position of the screed to the layer thickness h_{Bset} at or shortly before the position of the offset as continuously as possible. For example, the offset h_{F} can be higher than the current layer thickness h_{B} such that the adjustment line has a continuous gradient. This results in increasing set values for the layer thickness from position to position. Of course, h_{F} can also be smaller than h_{B} such that the set values decrease along the adjustment line.

According to a first variation, it can be assumed that no further layer is to be applied to the region 24 in the working step to be leveled here such that the position of the offset is to be approached exactly during the height control (optionally for taking into account the rolling measure). In this case, h_{Bset} at the position of the offset is equal to h_{F} or equal to h_{F}+W.

For the case (second variation) that a further layer is to be applied to the region 24 in the same working step starting from the position of the offset V, h_{Bset} at the position of the offset can be corrected upward, i.e. by the height of the layer to be applied to the region 24.

According to embodiments, the controller is configured to perform the height control at the position V according to h_{Bset} and according to further embodiments in the transition region according to the adjustment line G. For this purpose, the controller determines the set values, e.g. continuously increasing (adjustment) set values or continuously decreasing (adjustment) set values, over the adjustment distance D or along the adjustment line G.

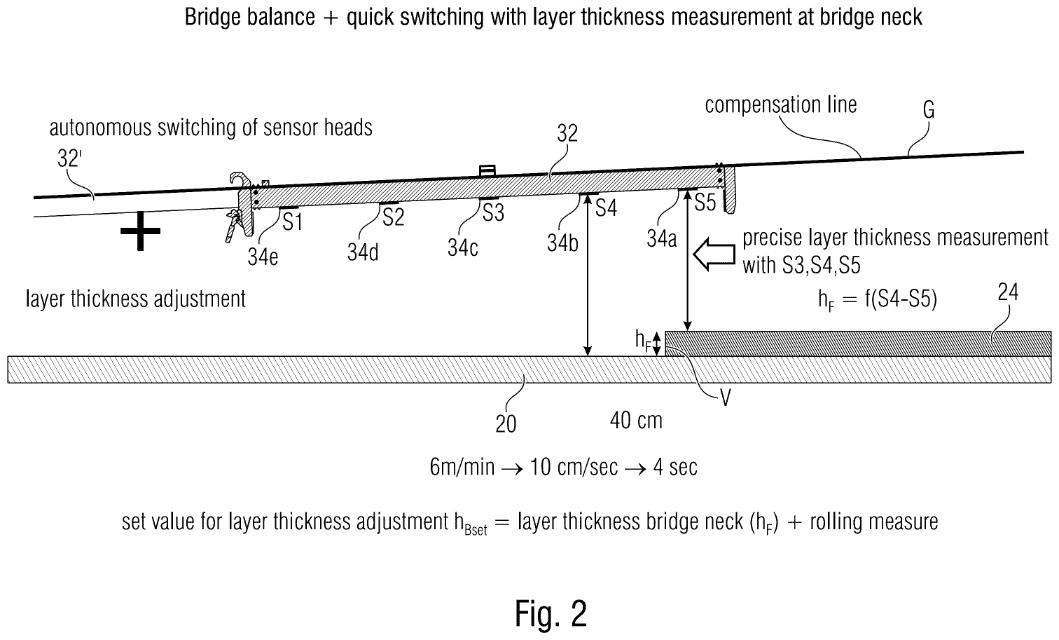

FIG. 2 shows the measuring system 30 with the sensors 34a, 34b, 34c, 34d and 34e. These are arranged on a common carrier 32. This carrier 32 can also be extended by a further segment, as shown by 32′. This further segment 32′ may of course also have further sensors.

As shown, the further segment 32′ together with the segment 32 forms a measuring bar with integrated sensors 34a-34e etc. In this embodiment, all sensors 34a-34e have in common that they are arranged in front of the screed and can therefore determine the ground 20 or the layer 24 already arranged on the ground or the offset V of the layer 24 from the layer 20. The offset V or the height h_{F} of the offset V can be determined as a function of the sensor signals S4 and S5 of the sensors 34b and 34a. During travel, the sensors 34a-34e scan the ground 20 or 24 continuously. For this purpose, the sensors 34a-34e are each spaced apart from one another, e.g. by means of a distance of 40 cm from one another. This knowledge makes it possible for different sensor values to be able to be used together with a sensor, e.g. the sensor 34a or the sensor 34b, in order to scan the offset V over an area. For example, several sensor values S5 can thus be settled with several sensor values S4.

According to an embodiment, averaging temporally successive sensor values S5 for determining the front sensor value S5 or temporally successive sensor values S4 for determining the rear sensor value S4 is conceivable. In other words, these can be scanned or sampled over time, for example. As a result, small occasions of unevenness can be filtered out. Specifically for the rear sensor value, averaging over the sensors 34b-34e with the sensor signals S1 to S4 could alternatively also be carried out in order to determine a common value.

Furthermore, it is also possible to accurately detect the step or the position of the step. By adjusting the sensor values S5 and S4 before the step, an offset between these two sensor values can also be determined, which results from the oblique arrangement of the measuring bar 32 or 32′ shown here. It would also be conceivable for the bridge neck V or generally the offset to be detected on the basis of the change in the sensor values S5 when the offset V is travelled over. For this purpose, the detection algorithm can, for example, detect an offset V when substantially constant sensor values S5 jump directly to a different height level from one position so that the sensor values then again remain substantially constant from this position. For this purpose, the sensor signals S5 are evaluated over time. Detecting the offset V can then result in a rapid switchover so that an adjustment or automatic adjustment of the layer thickness to the offset V is performed. Alternatively, the height measurement h_{F} can be improved using the sensor signals S1, S2 and S3 of the sensors 34e, 34d and 34c by determining the gradient of the carrier 32 or 32′, for example using a regression line.

According to further embodiments, two regression lines can be determined, i.e. one for determining a height value with respect to the ground 20 and one for determining a height value with respect to the ground 24. These two regression lines can be determined using several sensor values, for example the sensor values S1, S2, S3 and S4 for the rear regression line. For determining the front regression line, it would be conceivable for several (e.g. two) sensors offset with respect to one another to be used. According to an embodiment, the adjustment line G is parallel to the rear regression line.

Based on detecting the offset V, two things can thus be performed according to embodiments. According to a first variation, the mode for adjusting the layer thickness can be activated. An exemplary mode will be explained below. According to an embodiment, a layer thickness measurement can then be performed at the bridge neck in order to provide this layer thickness measurement, that is to say the measurement of the offset h_{F} at the position V, for the adjustment. According to a further embodiment, it would be conceivable for autonomous switching of the sensor heads 34a-34e to be performed starting from the position V so that they continue to be used for leveling, but corrected by the offset h_{F}. In this case, for example, the correction can be performed by means of a type of offset. Knowing the sections of the sensor heads, e.g. 40 cm from one another, switching the subsequent sensors 34b-34e is possible using the current travel speed, e.g. 6 m per minute, which corresponds to approximately 10 cm per second. The 40 cm are reached after approximately 4 s so that a further sensor 34b, 34c would then have to be switched correspondingly every 4 s.

According to embodiments, the adjustment can be performed as follows on the basis of the current layer thickness and the determined offset h_{F}. Between these two points, an adjustment line G can be determined which predefines set values over the adjustment distance D. The set values can increase, for example, if h_{B} is greater than the current layer thickness, or decrease if h_{B} is smaller than the current layer thickness. In this case, it is also to be taken into account whether the layer is to be further applied to the ground 24 starting from the position V or whether the layer 22 to be applied is to follow directly to 24. In this case, according to embodiments, the rolling measure is also taken into account so that the layer thickness at the bridge neck h_{F} and the rolling measure W are used as the set value for the layer thickness during the adjustment h_{Bset} at the position V. Excursion to the rolling measure: In a subsequent working step, the layer thickness is reduced during rolling, for example, by the rolling measure.

This results in the formula h_{Bset}=h_{F}+W. This set value h_{Bset} is then used together with the current set value at the position of the screed to determine the adjustment line G and the set values which can be determined in dependence on the adjustment line G. The road paver can then control the screed 10 according to these set values to perform the adjustment over the adjustment distance D.

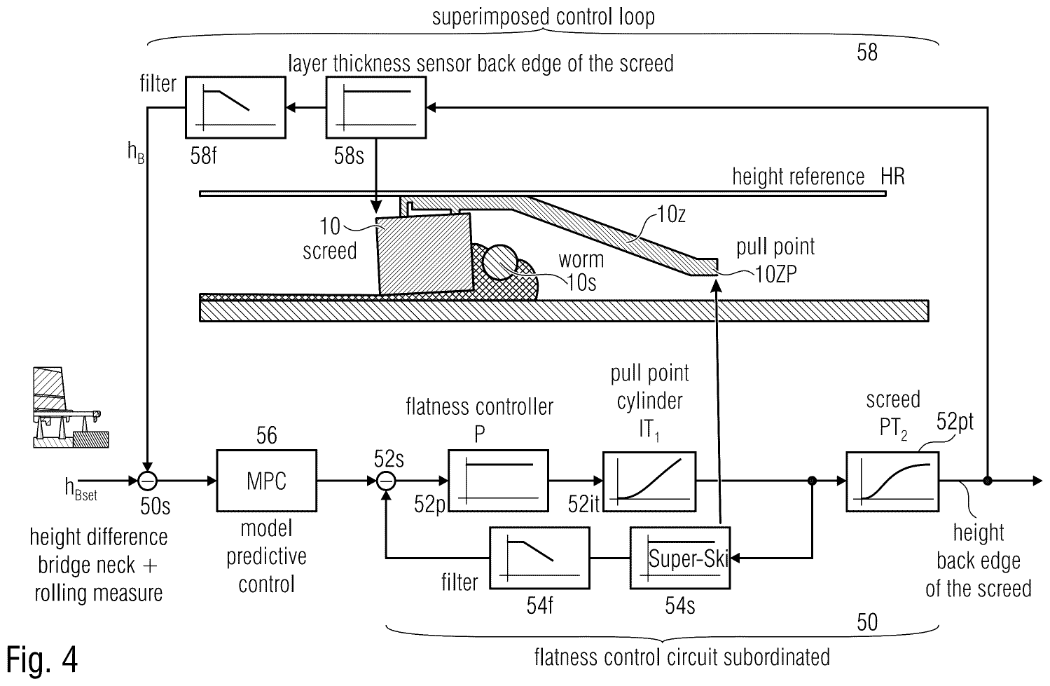

Excursion to the control as explained e.g. in FIG. 4: When using a corresponding control loop, determining the adjustment line G is not necessary separately since the control loop performs the adjustment of the height values along the line G over the distance D (from screed position to offset position).

At this point, it is to be noted that, according to embodiments, the adjustment line G is parallel to the carrier 32 or 32′.

In the above embodiments, it was assumed that the offset results from a bridge neck. The expansion joint of the bridge can be arranged, for example, in the region of this bridge neck. This predefines the height of 24 by additional elements, e.g. metal parts. As an alternative to a bridge neck, the offset V can also be a neck to another asphalt layer, e.g. in the case of repair of an asphalt layer (asphalt layer to be produced and present butt-to-butt (in the direction of travel of the road paver)).

Controlling the screed will be explained below referring to FIG. 4. The controller may have a flatness control loop 50 which comprises the three controllers P connected in series for flatness control, IT1 for adjusting the tension point cylinder andPT2 for modulating the screed. These elements are provided with 52P, 52IT and 52PT. Based on this series chain 52P, 52IT and 52PT, a feedback loop 54 with the Super-Ski controller 54s and a filter 54f may also be provided. This feedback loop returns the signal of the IT controller, processes it with the respective algorithm 54s or the respective filtering 54f in order then to be fed back to the flatness controller 52P at the input of the controller 52P by a subtraction element 52s. By means of the flatness controller 52P, taking into consideration the tension point adjustment IT and the screed behaviorPT, the height of the screed trailing edge is implemented based on a set height at the input of the flatness controller. In this feedback loop 54s and 54f, a further control can then be superimposed which minimizes long-wave unevenness. In addition, a so-called “model-predictive control” 56 may also be provided which is arranged upstream of the flatness controller 50. This “model-predictive control” comprises a prediction model for taking into account expected reactions of the screed based on the desired change. For example, the floating behavior can thus also be taken into account, which results from a change in the angle of attack or tension point adjustments. Furthermore, the “model-predictive control” 56 can also take into account factors, such as e.g. the amount of asphalt to be maintained at the worm 10s or also screed parameters, such as e.g. vibration of the screed 10.

This control chain comprises 56 as an optional component and 50 acts on the tension point adjustment 10zp of the pull arm 10z of the screed 10. The aim in this case is to guide the screed 10 along the height reference h_{R}.

For this purpose, according to further embodiments, a further control loop 58 can be superimposed. This represents a feedback loop at the output of 52 PT to the input of 56. A subtraction point 56s is provided at the input 56. The superimposed control loop 58 is configured to perform control by means of the layer thickness sensor at the rear edge of the screed (cf. sensor system 35 from FIG. 1A or 1C). As a result, the leveling takes place according to the principle of the superimposed control loop 58.

By means of the sensors 38a et seq., which are arranged on the part 35 of the measuring system, a layer thickness hp at the position of the screed is determined taking into account the sensor signals of the sensors 34a et seq. of the measuring system part 30. For this purpose, a simple difference calculation can be used or else a determination can be performed using two regression lines.

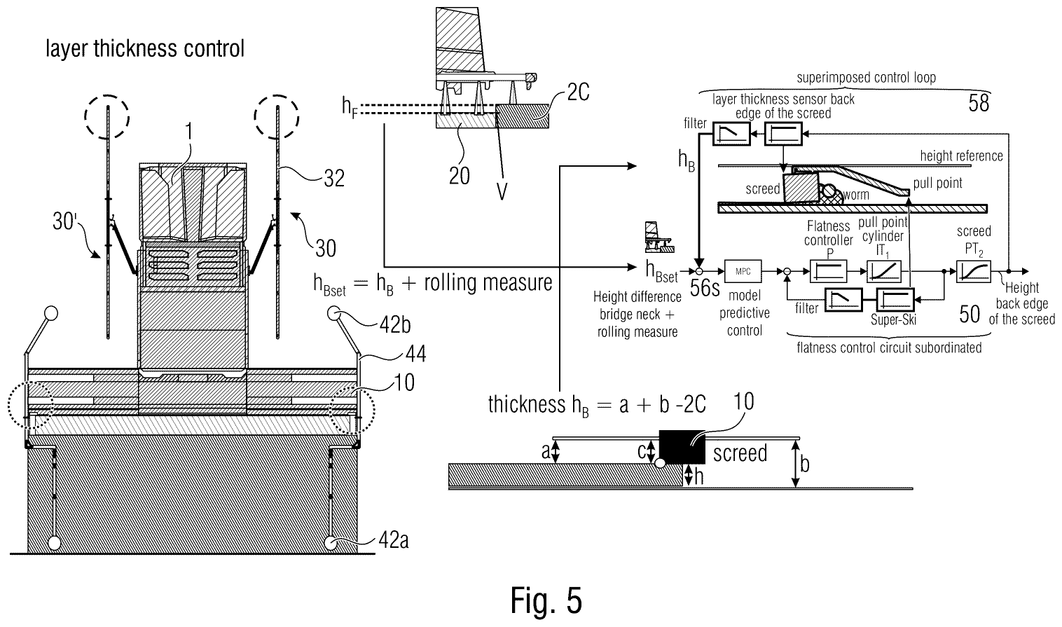

The further simple variation of the layer thickness determination is shown in FIG. 5. Here, a height value a behind the screed, e.g. by means of the sensor 42a, and a height value b in front of the screed, e.g. by means of the sensor 42b, are determined on the screed 10. A sum of these values A+B is subtracted from the mounting height C of the measuring system in order to determine the layer thickness h. The following formula results from this: h_{B}=A+B−2C. According to an embodiment, the layer thickness hg in this variation can be used by a separate layer thickness measuring system comprising the sensors 42a and 42b which are mounted on a carrier 44. The carrier 44 is connected to the screed 10.

Alternatively, a first regression line is determined by means of the front sensors 34a and 34b, while a second regression line is determined by means of a rear sensor 38a et seq. The distance between these two regression lines provides information on the layer thickness hp at the position of the screed. This measured value is then fed to the control loop using the controller 58s for determining the layer thickness at the rear edge of the screed and an optionally downstream filter 58f, i.e. via the subtraction point 50s. Here, the current layer thickness value h_{B} is compared to the set value h_{Bset}.

Based on the offset h_{F} determined in connection with FIG. 2, the value h_{Bset} at the position of the offset and also the set values according to h_{Bset} can be determined along the adjustment line. These are fed to the control loop via the subtraction point 50s. Thus, taking into consideration h_{Bset}, the height at the rear edge of the screed can be controlled for adjustment. This is shown again in detail referring to FIG. 5. FIG. 5 shows the superimposed control loops 50 and 58 for controlling the height at the rear edge of the screed, wherein a height value hg at the rear edge of the screed is fed via the control loop 58 and the hp set value for the offset V between the layers 20 and 24 is fed via the subtraction point 56s. As shown here, for example, the layer thickness measured values h_{B} can be determined by the measuring system with the sensors 42a and 42b, while the offset h_{F} is determined by means of the measuring system 30.

According to embodiments, the layer thickness measuring system with the sensors 42a and 42b can be arranged both on the one side and on the other side or also on both sides of the screed 10. According to embodiments, it is also possible that the offset h_{F} is determined both on the one side and on the other side of the construction machine 1. By way of example, a further measuring system 30′ at the height of the tractor is provided in FIG. 5. Using the measuring systems arranged in parallel, the offset V can be determined on both sides (left and right) of the construction machine 1.

According to embodiments, it is thus possible that using the measuring system 30 or 30′, which comprises sensors in front of (as seen in the direction of travel) the screed 10 or advantageously even in front of the construction machine 1, a set layer thickness determination can be performed at the bridge neck (or comparable constructions). According to further embodiments, the adjustment is performed according to an adjustment line. The calculation unit is configured to calculate such an adjustment line continuously. The controller, as is also used, for example, in the Super-Ski system, comprises the elements 56, 54s and 54f together with the controllers 52p, 52ᵢₜ and 52pt for calculating the adjustment line. In this respect, according to embodiments, the controller illustrated in FIG. can perform adjustment directly along the adjustment line G (cf. FIG. 2) over the adjustment distance D, i.e. on the basis of the two determined values h_{B} (=layer thickness at the screed 10) and h_{Bset} (with and/or without taking into consideration a rolling measure; =height of the offset V). Here, for example, the corresponding screed behavior is also taken into account via the tension point adjustment and the prediction models. According to embodiments, D is dependent on the length or the distance of the sensors 34a and/or 34b when compared to the control point of the screed 10. In FIG. 2, the adjustment distance D was exemplarily seen as the distance between the sensor 34a and the rear edge of the screed. According to embodiments, however, this distance D may also vary depending on the adjustment point of the screed.

According to embodiments, it is possible for the foremost sensor 34a or the foremost sensors 34a, 34b in the measuring system, such as, for example, the Super-Ski system, on the one hand to determine the offset height h_{F} at the bridge neck V and at the same time to initiate the process of autonomous adjustment of the layer thickness.

As already explained, when detecting the offset V or knowing the offset h_{F} for an optimum flatness control, those sensors 34a, 34b, 34c etc. which have reached the bridge neck V can be adjusted in the system taking h_{F} into account so that they can also be used again for the flatness control.

A potential measuring system will be explained below which, on the one hand, makes it possible to determine h_{F} at the position of the offset and, on the other hand, can also be used simultaneously for the flatness control/leveling and layer thickness determination.

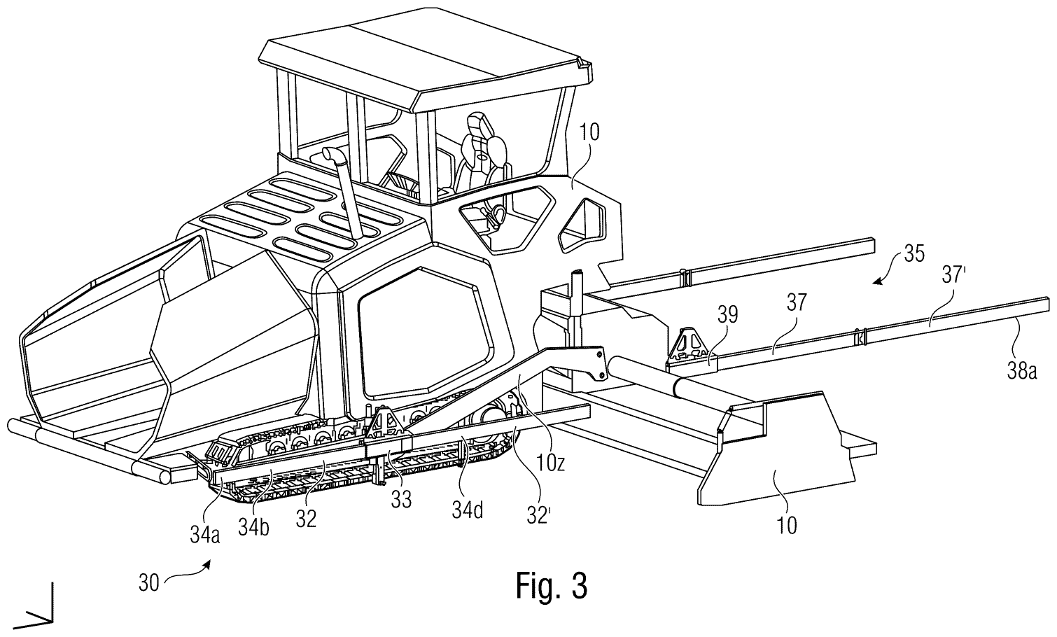

FIG. 3 shows a construction machine 1 with a screed 10 and a measuring system 30 arranged in front of the screed 10. The measuring system 30 is arranged on the pull arm 10z and comprises a carrier 32 and an extended carrier 32′. They can each comprise one or several sensors. Purely exemplarily, the sensors 34a, 34b and 34d are shown here. The carriers 32 and 32′ are connected to the pull arm 10z via a fastening unit 33. All sensors 34a to 34d are located in front of the screed, wherein the first sensor, i.e. the foremost sensor as seen in the direction of travel, is the sensor 34a. The sensors 34a and 34b determine the offset, for example. All sensors 34a to 34d can be used for the flatness control. Furthermore, the sensors 34a to 34d can be used as sensors of the layer thickness measuring system; this is performed, for example, by determining a regression line or else by averaging the sensor values (cf. sensor value B from FIG. 5). Furthermore, the measuring system also comprises the part 35 arranged behind the screed, comprising, for example, two carriers 37 and 37′, which are connected to the screed via a connection 39 and are also directly connected to one another. Sensors 38a, which determine a height value behind the screed, are arranged on the carriers 37. The sensor values in front of the screed can be used together with the sensor values behind the screed, on the one hand, for leveling/flatness control and above all for the layer thickness measurement.

As shown here, according to embodiments, the sensor system comprising the two parts 32 and 35 can be provided both on the one (e.g. right) side and on the other (e.g. left) side.

As already explained above, both the measuring system 35 and the measuring system 30 can comprise several sensors, which are taken into account together, for example, using a regression line or averaging.

Although some aspects have been described in connection with an apparatus, it is understood that these aspects also represent a description of the corresponding method so that a block or a component of an apparatus is also to be understood to be a corresponding method step or feature of a method step. In analogy, aspects which have been described in connection with or as a method step also represent a description of a corresponding block or detail or feature of a corresponding apparatus. Some or all of the method steps can be performed by a hardware apparatus (or using a hardware apparatus), such as, for example, a microprocessor, a programmable computer or an electronic circuit. In some embodiments, some or several of the most important method steps can be performed by such an apparatus.

Depending on certain implementation requirements, embodiments of the invention can be implemented in hardware or in software. The implementation can be implemented using a digital storage medium, for example a floppy disk, a DVD, a Blu-ray disc, a CD, ROM, PROM, an EPROM, EEPROM or a FLASH memory, a hard disk or another magnetic or optical memory on which electronically readable control signals are stored which can cooperate or cooperate with a programmable computer system such that the respective method is implemented. Therefore, the digital storage medium can be computer-readable.

Some embodiments according to the invention thus comprise a data carrier which has electronically readable control signals which are able to cooperate with a programmable computer system such that one of the methods described herein is performed.

In general, embodiments of the present invention can be implemented as a computer program product with a program code, wherein the program code is operative to perform one of the methods when the computer program product runs on a computer.

The program code can, for example, also be stored on a machine-readable carrier.

Other embodiments comprise the computer program for performing one of the methods described herein, wherein the computer program is stored on a machine-readable carrier. In other words, an embodiment of the method according to the invention is thus a computer program which has a program code for performing one of the methods described herein when the computer program runs on a computer.

A further embodiment of the methods according to the invention is thus a data carrier (or a digital storage medium or a computer-readable medium) on which the computer program for performing one of the methods described herein is recorded.

A further embodiment of the method according to the invention is thus a data stream or a sequence of signals which represents or represent the computer program for performing one of the methods described herein. The data stream or the sequence of signals can, for example, be configured to be transferred over a data communication connection, for example via the Internet.

A further embodiment comprises a processing device, for example a computer or a programmable logic device, which is configured or adapted to perform one of the methods described herein.

A further embodiment comprises a computer on which the computer program for performing one of the methods described herein is installed.

A further embodiment according to the invention comprises an apparatus or a system configured to transmit a computer program for performing at least one of the methods described herein to a receiver. The transmission can be performed, for example, electronically or optically. The receiver can be, for example, a computer, a mobile device, a memory device or a similar apparatus. The apparatus or the system can comprise, for example, a file server for transmitting the computer program to the receiver.

In some embodiments, a programmable logic device (for example a field-programmable gate array, an FPGA) can be used to perform some or all of the functionalities of the methods described herein. In some embodiments, a field-programmable gate array can cooperate with a microprocessor to perform one of the methods described herein. In general, in some embodiments, the methods are performed by any hardware apparatus.

This can be universally usable hardware such as a computer processor (CPU) or hardware specific to the method, such as, for example, an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A leveling system for a road paver with a screed, comprising:
a measuring system;
and a controller;
wherein the measuring system comprises a first and a second sensor, wherein the first sensor is arranged in front of the second sensor in the direction of travel and is configured to measure a first distance from the first sensor to a further ground or surface with a height level offset by an offset in order to acquire a first height value; and wherein the second sensor is arranged in front of the screed of the road paver in the direction of travel and is configured to measure a second distance from the second sensor to a ground of the construction machine or a reference of the construction machine in order to acquire a second height value;
wherein the controller is configured to determine the offset on the basis of the first height value and the second height value by forming a difference, wherein the controller is also configured to determine a set value for adjustment on the basis of the offset;
wherein the controller is configured to control the screed in dependence on the set value.

2. The leveling system according to claim 1, wherein the set value is determined taking into account a rolling measure.

3. The leveling system according to claim 1, wherein the controller is configured to control the screed in dependence on an adjustment line, which extends over an adjustment distance and/or a predefined adjustment distance.

4. The leveling system according to claim 3, wherein the adjustment line is determined by a current layer thickness and/or wherein the adjustment line is determined by a set layer thickness at the position of the offset and/or the set value.

5. The leveling system according to claim 1, wherein the first height value and/or the second height value is determined over one or more sensors and/or one or more positions.

6. The leveling system according to claim 1, wherein the first height value is determined using a first regression line and/or wherein the second height value is determined using a second regression line.

7. The leveling system according to claim 1, wherein the controller is configured to detect the offset in the ground; or wherein the controller is configured to detect the offset in the ground and to initiate the adjustment of the layer thickness.

8. The leveling system according to claim 1, wherein the controller comprises one or more superimposed control loops.

9. The leveling system according to claim 8, wherein the controller comprises a flatness control loop; and/or
wherein the controller is configured to perform the control of the screed using a prediction model and/or taking into account a behavior of the screed over time and/or the distance.

10. The leveling system according to claim 8, wherein the controller is configured to perform control on the basis of a difference or sum of a height reference and the set value or on the basis of a difference or sum of a height reference and the set value while taking into account a rolling measure.

11. The leveling system according to claim 1, wherein the measuring system comprises one or more further sensors between the second sensor and the screed for leveling and/or layer thickness determination and/or a flatness controller; and/or
wherein the measuring system comprises one or more further sensors behind a screed for leveling and/or layer thickness determination and/or a flatness controller.

12. The leveling system according to claim 11, wherein the controller is configured to correct the height values, determined by the one or more further sensors, starting from a position of the offset and/or to correct the offset.

13. The leveling system according to claim 1, wherein the measuring system comprises a carrier on which the first and second sensor or the first and second sensor and one or more further sensors are arranged.

14. A method for operating a leveling system for a road paver with a screed, comprising:
measuring a first distance from a first sensor to a further ground or surface with a height level offset by an offset, wherein the first sensor is arranged in front of the second sensor in the direction of travel in order to acquire a first height value;
measuring a second distance from the second sensor to a ground of the construction machine or a reference of the construction machine in order to acquire a second height value;
determining a set value for adjustment on the basis of the first height value and the second height value and determining a set value for adjustment on the basis of the offset; and
controlling the screed in dependence on the set value.

15. A non-transitory digital storage medium having stored thereon a computer program comprising program code for performing a method for operating a leveling system for a road paver with a screed, comprising:
measuring a first distance from a first sensor to a further ground or surface with a height level offset by an offset, wherein the first sensor is arranged in front of the second sensor in the direction of travel in order to acquire a first height value;
measuring a second distance from the second sensor to a ground of the construction machine or a reference of the construction machine in order to acquire a second height value;
determining a set value for adjustment on the basis of the first height value and the second height value and determining a set value for adjustment on the basis of the offset; and
controlling the screed in dependence on the set value,
when the computer program is run by a computer.
